(19) United States
(12) Patent Application Publication
(10) Pub. No.: US 2009/0247139 A1
(43) Pub. Date: Oct. 1, 2009

(54) SYSTEM FOR ADAPTING ONLINE ADVERTISING CAMPAIGNS TO INCORPORATE MOBILE ADVERTISING

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennet, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/059,325

(22) Filed: Mar. 31, 2008

(51) Int. Cl. H04M 3/00; H04M 1/02

(52) U.S. Cl. 455/418; 455/566

(57) ABSTRACT

A system is described for adapting online advertising campaigns to incorporate mobile advertising. The system may include a processor, a memory and an interface being operatively connected. The memory may store ad groups of an advertiser, and mobile advertisements. An ad group may include keywords and web advertisements. The interface may allow the advertiser to associate the ad groups with mobile carriers. The processor may identify the ad groups and may provide the interface to the advertiser. The processor may receive associations of ad groups and mobile carriers. The processor may create mobile advertisements based on the web advertisements and mobile carriers. The processor may associate the mobile advertisements and the mobile carriers with the ad groups. The processor may provide one of the mobile advertisements to a user when the user performs a mobile search for one of the keywords on a mobile device associated with the mobile carriers.

### TECHNICAL FIELD

The present description relates generally to a system and method, generally referred to as a system, for adapting online advertising campaigns to incorporate mobile advertising, and more particularly, but not exclusively, to providing online advertisers with an interface for incorporating mobile advertising into an online advertising campaign.

### BACKGROUND

The mobile advertising market may grow as users become more comfortable with using their mobile phones as web access devices. The mobile phone may present advertisers with access to consumers everywhere the consumers take their mobile phones. However, users may interact with a mobile device differently than they might interact with a computer. Semantics and user intent may differ on a mobile device and on a computer, resulting in different keywords searched for by users on mobile devices and on computers. Thus it may be difficult for an advertiser to incorporate mobile advertising into their existing online advertising campaign.

### SUMMARY

A system is disclosed for adapting online advertising campaigns to incorporate mobile advertising. The system may include a processor, a memory and an interface. The memory may store ad groups of an advertiser, and mobile advertisements. An ad group may include keywords and web advertisements. The interface may allow the advertiser to associate the ad groups with mobile carriers. The processor may identify the ad groups and may provide the interface to the advertiser. The processor may receive, from the advertiser, associations of ad groups and mobile carriers. The processor may create mobile advertisements based on the web advertisements and mobile carriers. The processor may associate the mobile advertisements and the mobile carriers with the ad groups. The processor may provide one of the mobile advertisements to a user when the user performs a mobile search for one of the keywords on a mobile device associated with the mobile carriers.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for adapting online advertising campaigns to incorporate mobile advertising.

FIG. 2 is a block diagram of a simplified view of a network environment implementing the system of FIG. 1 or other systems for adapting online advertising campaigns to incorporate mobile advertising.

FIG. 3 is a flowchart illustrating operations of incorporating mobile advertising into existing advertising groups in the system of FIG. 1, or other systems for adapting online advertising campaigns to incorporate mobile advertising.

FIG. 4 is a flowchart illustrating operations of incorporating mobile advertising into existing advertising campaigns in the system of FIG. 1, or other systems for adapting online advertising campaigns to incorporate mobile advertising.

FIG. 5 is a flowchart illustrating operations of a revenue generator in the system of FIG. 1, or other systems for adapting online advertising campaigns to incorporate mobile advertising.

FIG. 6 is a screenshot of a revenue generator's advertising campaign interface in the system of FIG. 1, or other systems for adapting online advertising campaigns to incorporate mobile advertising.

FIG. 7 is a screenshot of a revenue generator's advertising group interface in the system of FIG. 1, or other systems for adapting online advertising campaigns to incorporate mobile advertising.

FIG. 8 is a screenshot of a revenue generator's advertising group mobilization interface in the system of FIG. 1, or other systems for adapting online advertising campaigns to incorporate mobile advertising.

FIG. 9 is a screenshot of a revenue generator's advertising group interface displaying mobilized advertising groups in the system of FIG. 1, or other systems for adapting online advertising campaigns to incorporate mobile advertising.

FIG. 10 is a screenshot of a revenue generator's advertising campaign interface in the system of FIG. 1, or other systems for adapting online advertising campaigns to incorporate mobile advertising.

FIG. 11 is a screenshot of a revenue generator's advertising campaign mobilization interface in the system of FIG. 1, or other systems for adapting online advertising campaigns to incorporate mobile advertising.

FIG. 12 is a screenshot of a revenue generator's advertising campaign interface displaying mobilized advertising campaigns in the system of FIG. 1, or other systems for adapting online advertising campaigns to incorporate mobile advertising.

FIG. 13 is an illustration a general computer system that may be used in a system for adapting online advertising campaigns to incorporate mobile advertising.

### DETAILED DESCRIPTION

The present description relates generally to a system and method, generally referred to as a system, for adapting online advertising campaigns to incorporate mobile advertising, and more particularly, but not exclusively, to providing online advertisers with an interface for incorporating mobile advertising into an online advertising campaign.

The system may enable an advertiser to incorporate mobile advertising into an existing online advertising campaign. The system may allow an advertiser to utilize an existing online advertising tactics by incorporating mobile advertisements into existing advertising campaigns or existing advertising groups. The system may enable an advertiser without mobile expertise to create mobile advertisements and incorporate the mobile advertisements into an existing online advertising campaign. The system may streamline the process of building a mobile advertising campaign by allowing the advertiser to leverage existing online advertising components.

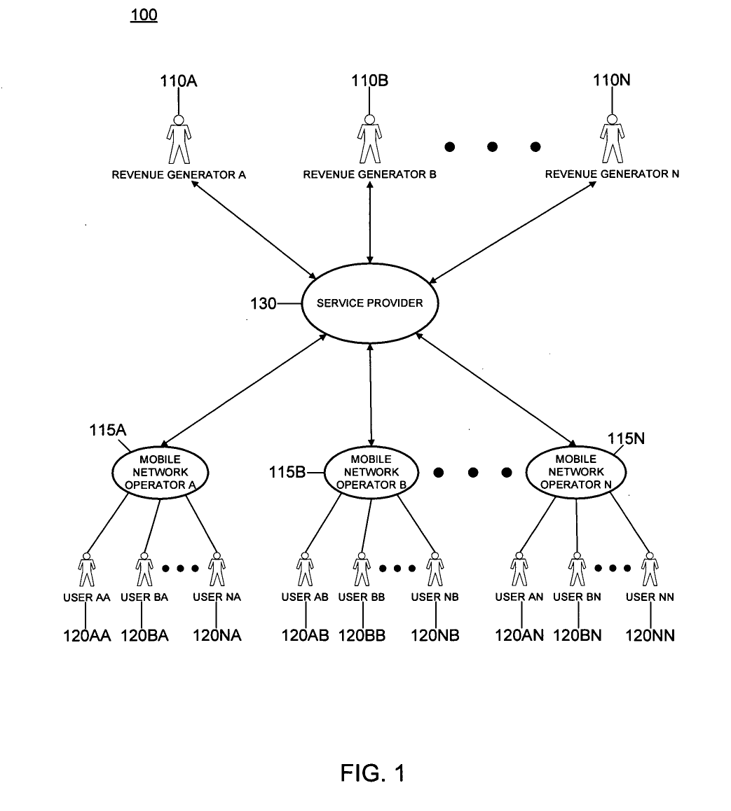

FIG. 1 provides a general overview of a system 100 for adapting online advertising campaigns to incorporate mobile advertising. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as online advertisers, a service provider 130, such as a portal or an advertising service provider, one or more mobile network operators (“MNOs”) 115A-N, more commonly referred to as mobile carriers, or simply carriers, and one or more users 120AA-NN, such as mobile subscribers or consumers the revenue generators 110A-N wish to target. The service provider 130 may implement an online and mobile advertising campaign management system incorporating an auction based and/or non-auction based advertisement serving system.

The advertising campaign management system may support targeting advertisements to the users 120AA-NN through a variety of advertising tactics, such as search targeting, content match targeting and behavioral profile targeting. Search targeting may refer to targeting advertisements to keywords provided by the users, content match targeting may refer to targeting advertisements to the content of a particular page, and behavioral profile targeting may refer to targeting advertisements to the behavior of the users 120AA-NN.

The revenue generators 110A-N may utilize the online advertising services provided by the service provider 130, but not the mobile advertising services. Alternatively or in addition the revenue generators 110A-N may utilize both the online and mobile advertising services of the service provider 130, but the revenue generators 110A-N may not maintain a mobile advertising campaign for each online advertising campaign. The revenue generators 110A-N may pay the service provider 130 to serve, or display, advertisements of their goods or services, such as on-line or mobile advertisements, to the users 120AA-NN, such as over mobile messaging, mobile web, the Internet, or generally any venue for displaying advertisements. The advertisements may include sponsored listings, banners ads, popup advertisements, mobile messages, or generally any way of attracting the users 120AA-NN to the web site or mobile site of the revenue generators 110A-N. The users 120AA-NN may utilize the services of the service provider 130 through web applications, mobile applications or standalone applications.

The service provider 130 may maintain a mobile portal and/or a web portal, such as a search site, where the service provider 130 may provide advertisements of the revenue generators 110A-N to the users 120AA-NN. The users 120AA-NN may use mobile devices to interact with the search site provided by the service provider 130 to search for information on the mobile web. Alternatively or in addition the service provider 130 may provide advertisements to a third party server, such as a third party search portal. The third party server may submit an advertisement request to the service provider 130 through an interface such as an application programming interface (“API”). The service provider 130 may use the date submitted with the request to retrieve and return relevant advertisements to the third party server.

Alternatively or in addition the service provider 130 may be an advertising services provider. Third party entities, such as the MNOs 115A-N may request advertisements from the service provider 130 through an API. The service provider 130 may return advertisements of the revenue generators 110A-N to the MNOs 115A-N relating to data submitted in the advertisement request. The MNOs 115A-N may then display the advertisements to the users 120AA-NN. The service provider 130 may share revenue with the mobile network operators MNOs 115A-N of the users 120AA-NN for displaying advertisements of the revenue generators 110A-N via their mobile networks. Alternatively or in addition the service provider 130 may share revenue with individual publishers for displaying advertisements of the revenue generators 110A-N on their mobile and/or web sites. The service provider 130 may supply the API to the MNOs 115A-N enabling the MNOs 115A-N to request advertisements from the service provider 130.

The MNOs 115A-N may provide a mobile network to the users 120AA-NN which may provide a variety of services to the users 120AA-NN, such as the ability to send and receive phone calls, send and receive mobile messages, to access the internet and/or the mobile web, or generally any service that may be implemented on a mobile device. The MNOs 115A-N may store data describing the users 120AA-NN, such as billing addresses, call histories, messaging histories, or generally any data regarding the users 120AA-NN that may be available to the MNOs 115A-N.

The amount the revenue generators 110A-N may pay the service provider 130 may be based on one or more factors. These factors may include impressions, click throughs, conversions, and/or generally any metric relating to the advertisement and/or the behavior of the users 120AA-NN. The impressions may refer to the number of times an advertisement may have been displayed to the users 120AA-NN. The click throughs may refer to the number of times the users 120AA-NN may have clicked through an advertisement to a web site, mobile web site or mobile landing page of one of the revenue generators 110A-N, such as the revenue generator A 110A. The conversions may refer to the number of times a desired action was taken by the users 120AA-NN after clicking though to a web site of the revenue generator A 110A. The desired actions may include submitting a sales lead, making a purchase, viewing a key page of the site, downloading a whitepaper, and/or any other measurable action. If the desired action is making a purchase, then the revenue generator A 110A may pay the service provider 130 a percentage of the purchase.

In the system 100, the revenue generators 110A-N may interact with the service provider 130, such as via a web application. The revenue generators 110A-N may send information, such as billing, website or mobile site, queries, and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application. Alternatively or in addition the revenue generators 110A-N may interact with the service provider 130 via a mobile device.

The users 120AA-NN may also interact individually with the service provider 130, through the mobile network operators 115A-N, such as via a mobile phone or any mobile device capable of communicating with the mobile network operators 115A-N. The users 120AA-NN may interact with the service provider 130 via a mobile web based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however the system 100 may apply to any revenue generators 110A-N who may desire to serve advertisements to users 120AA-NN over mobile devices.

A revenue generator A 110A may maintain one or more accounts with the service provider 130. For each account the revenue generator A 110A may maintain one or more campaigns. For each campaign the revenue generator A 110A may maintain one or more ad groups. An ad group may be associated with one or more keywords and one or more advertisements.

The service provider 130 may provide the revenue generator A 110A with an interface for incorporating mobile advertising into their existing online advertising campaigns. The interface may allow the revenue generator A 110A to incorporate mobile advertising at the campaign level or at the ad group level. The interface may allow the revenue generator A 110A to associate each campaign and/or ad group with one or more mobile advertisements and one or more MNOs 115A-N, such as the MNO A 115A.

The interface may allow the revenue generator A 110A to associate one or more types of mobile advertisements, such as mobile listings and mobile call offers. A mobile listing may be a textual mobile advertisement linking to a mobile site of the revenue generator A 110A. If the revenue generator A 110A does not have a mobile site for one of the MNOs 115A-N, the revenue generator A 110A may associate a mobile call offer. The mobile call offer may be a mobile advertisement that links to a phone number associated with the revenue generator A 110A. When a user A 120A clicks on a mobile call offer, the user A 120A is provided with the telephone number associated with the revenue generator A 110A.

Furthermore, the service provider 130 may generate reports based on the data collected from the users 120AA-NN and communicate the reports to the revenue generators 110A-N to assist the revenue generators 110A-N in measuring the effectiveness of their online and mobile advertising campaigns. The reports may indicate the number of times the users 120AA-NN viewed a mobile and/or web advertisement of the revenue generators 110A-N, the number of times the users 120AA-NN clicked on a web and/or mobile advertisement of the revenue generators 110A-N, or generally any information useful to the revenue generators 110A-N.

More detail regarding the aspects of a mobile advertising auction-based systems, as well as the structure, function and operation of the service provider 130 as a mobile advertising provider, as mentioned above, can be found in commonly owned U.S. patent application Ser. No. 11/712,276, filed on Feb. 28, 2007, entitled, “SYSTEM FOR SERVING ADVERTISEMENTS OVER MOBILE DEVICES,” which is hereby incorporated herein by reference in its entirety. The systems and methods herein associated with mobile advertising campaign management may be practiced in combination with methods and systems described in the above-identified patent application incorporated by reference.

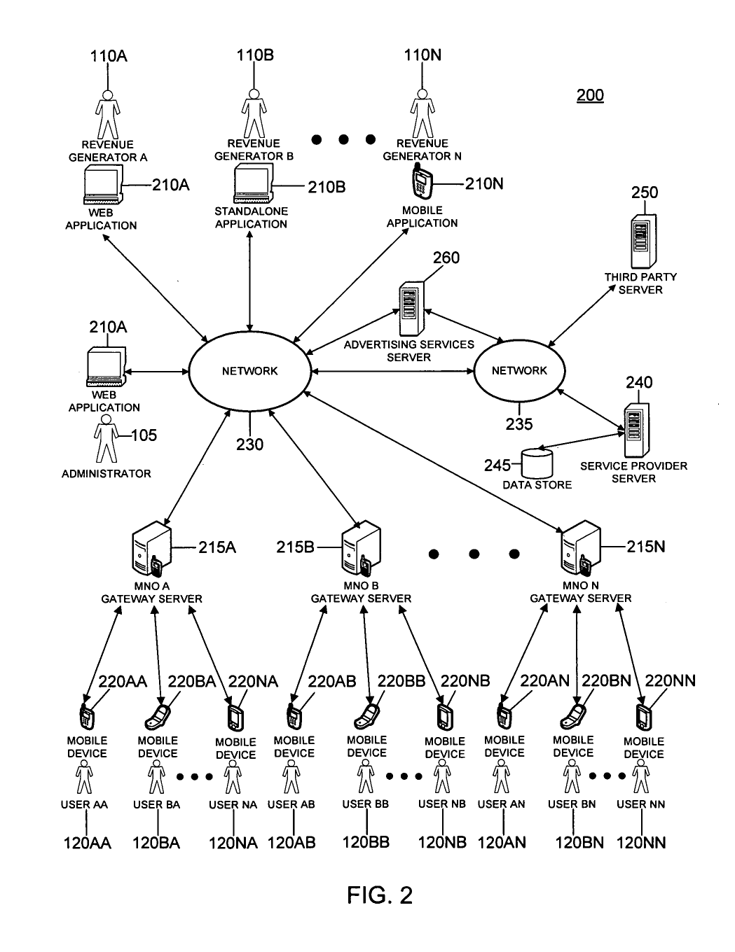

FIG. 2 provides a simplified view of a network environment implementing a system 200 for adapting online advertising campaigns to incorporate mobile advertising. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile apps, which may be running on one or more mobile devices 220AA-NN. The system 200 may also include one or more MNO gateway servers 215A-N, a network 230, a network 235, a data store 245, the service provider server 240, a third party server 250, and an advertising services server 260.

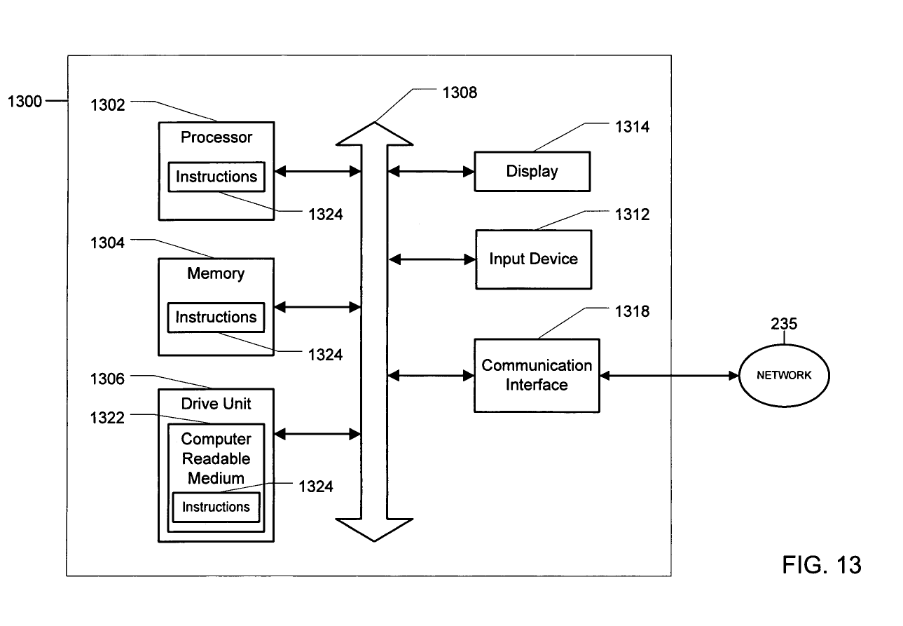

Some or all of the advertisement services server 260, service provider server 240, and third-party server 250 may be in communication with each other by way of network 235 and may be implemented with the system or components described below in FIG. 13. The advertisement services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The data store 245 may be operative to store data, such as data relating to interactions with the users 120AA-NN. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235, through the web applications, standalone applications or mobile applications 210A-N.

The users 120AA-NN may use a mobile application running on a mobile device 220AA-220NN, such as a mobile web browser, to communicate with the service provider server 240, via the MNO gateway servers 215A-N and the networks 230, 235. The service provider server 240 may communicate to the users 120AA-NN via the networks 230, 235 and the MNO gateway servers 215A-N, through the mobile devices 220AA-NN. Alternatively or in addition the users 120AA-NN may use a web application 210A, or a standalone application 210B, to communicate with the service provider 240. In this case the users 120AA-NN may communicate with the service provider 130 directly through the networks 230, 235, and not through the MNO gateway servers 215A-N.

The web applications, standalone applications, mobile applications and mobile devices 210A-N, 220AA-NN may be connected to the network 230 in any configuration that supports data transfer. This may include a data connection to the network 230 that may be wired or wireless. Any of the web applications, standalone applications and mobile applications 210A-N, may individually be referred to as a client application. The web application 210A may run on any platform that supports web content, such as a web browser or a computer, a mobile phone, personal digital assistant (PDA), pager, network-enabled television, digital video recorder, such as TIVO, automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with the revenue generator B 110B. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile application 210N may run on any mobile device which may have a data connection. The mobile applications 210N may be a web application 210A, a standalone application 210B, or a mobile browser. The mobile devices 220AA-NN may be one of a broad range of electronic devices which may include mobile phones, PDAs, and laptops and notebook computers. The mobile devices 220AA-NN may have a reduced feature set, such as a smaller keyboard and/or screen, and may be incapable of supporting a traditional web search.

The data connection of the mobile devices 220AA-NN may be a cellular connection, such as a GSM/GPRS/WCDMA connection, a wireless data connection, an internet connection, an infra-red connection, a Bluetooth connection, or any other connection capable of transmitting data. The data connection may be used to connect directly to the network 230, or to connect to the network 230 through the MNO gateway servers 215A-N.

The MNO gateway servers 215A-N may control the access the mobile devices 220AA-NN may have to the networks 230, 235. The MNO gateway servers 215A-N may also control the technology supporting the respective mobile devices 220AA-NN. This may affect aspects of the user experience, such as signal strength and availability, speed and billing mechanisms. For example, the MNO A gateway server 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile devices 220AA-NN may only support one of the aforementioned formats.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may receive requests from the users 120AA-NN and the revenue generators 110A-N and may serve web pages and/or mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. Alternatively or in addition, the third party server may be an ESME server. The advertising services server 260 may provide a platform for the inclusion of advertisements in pages, such as web pages or mobile pages. The advertisement services server 260 may be used for providing mobile advertisements that may be displayed to the users 120AA-NN. The third party server 250 may request advertisements from the service provider server 240 or the advertisement services server 260 via an API.

The service provider server 240, the third party server 250 and the advertising services server 260 may be one or more computing devices of various kinds, such as the computing device 1300 in FIG. 13. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120AA-NN and the revenue generators 110A-N. The advertising services server 260 may provide a platform for the inclusion of advertisements in pages, such as web pages. The advertising services server 260 may also exist independent of the service provider server 240 and the third party server 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

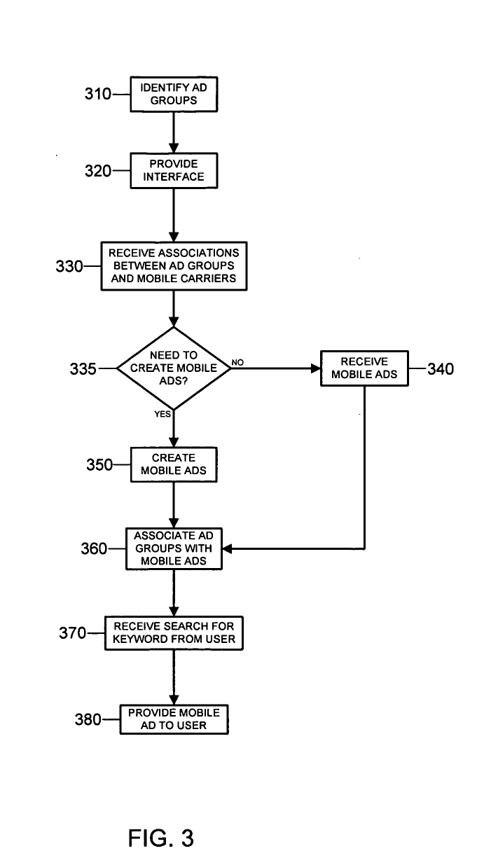

FIG. 3 is a flowchart illustrating operations of incorporating mobile advertising into existing advertising groups in the system of FIG. 1, or other systems for adapting online advertising campaigns to incorporate mobile advertising. At block 310 the service provider 130 may identify the existing ad groups of the revenue generator A 110A. The existing ad groups may be associated with queries and web advertisements. At block 320 the service provider 130 may provide an interface to the revenue generator A 110A allowing the revenue generator A 110A to associate the ad groups with one or more of the MNOs 115A-N. At block 330 the service provider 130 may receive, from the revenue generator A 110A via the interface, an indication of the MNOs 115A-N to be associated with each ad group.

At block 335 the service provider 130 may determine whether the revenue generator A 110A has mobile advertisements to associate with the ad group or whether mobile advertisements need to be created to associate with the ad group. If, at block 335, mobile advertisements need to be created, the system 100 may move to block 350. At block 350 the service provider 130 may provide the revenue generator A 110A with an interface for creating mobile listings, mobile call offers, or generally any mobile advertisement. Alternatively or in addition, the service provider 130 may automatically create mobile advertisements for the revenue generator A 110A based on the existing web advertisements of the revenue generator A 110A and/or the account information of the revenue generator A 110A. For example, the service provider may take the title, or display text of an existing web advertisement and use it as the display text of a mobile advertisement. The service provider A 110A may use a phone number associated with the account of the revenue generator A 110A for a mobile call offer. Alternatively or in addition the service provider 130 may use the URL of the web site of the revenue generator A 110A as the destination URL in a mobile listing.

If, at block 335, mobile advertisements do not need to be created, the system 100 may move to block 340. At block 340 the service provider 130 may receive one or more mobile advertisements from the revenue generator A 110A. At block 360 the service provider 130 may associate the mobile advertisements with the ad groups and MNOs 115A-N identified by the revenue generator A 110A in block 330. Alternatively or in addition the revenue generator A 110A may identify individual ad groups to associate with each of the mobile advertisements.

At block 370 the service provider 130 may receive a search query from a user AA 120AA on a mobile device 220AA associated with the MNO A 115A. The search query may be a query associated with one of the ad groups of the revenue generator A 110A. At block 380 the service provider 130 may provide one of the mobile advertisements of the revenue generator A 110A associated with the ad group and the MNO A 115A to the user AA 120AA.

Alternatively or in addition the ad groups of the revenue generator A 110A may include behavioral targeting advertising and/or content matching advertising tactics. In the case of behavioral targeting, the service provider 130 may provide a mobile advertisements of the revenue generator A 110A to a user AA 120AA on a mobile device 220AA associated with the mobile carrier A 115A if the mobile behavior of the user AA 120AA coincides with the behavioral profile being targeted. The service provider 130 may attempt to link the behavioral profiles of the user AA 120AA on the web and on the MNOs 115A-N. In the case of content matching, the service provider 130 may display a mobile advertisement of the revenue generator A 110A when the content of a mobile page being viewed by the user AA 120AA matches the content targeted by the ad group.

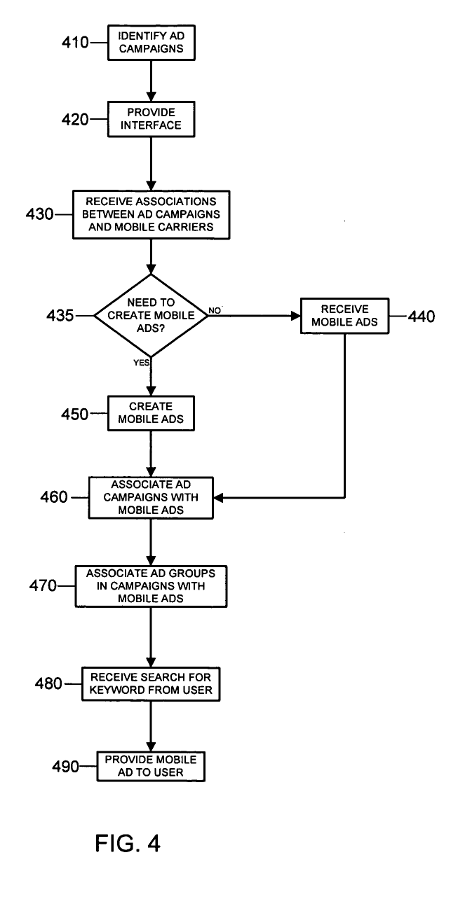

FIG. 4 is a flowchart illustrating operations of incorporating mobile advertising into existing advertising campaigns in the system of FIG. 1, or other systems for adapting online advertising campaigns to incorporate mobile advertising. At block 410 the service provider 130 may identify the existing advertising campaigns of the revenue generator A 110A. The existing advertising campaigns may be associated with one or more ad groups. The ad groups may be associated with queries and web advertisements. At block 420 the service provider 130 may provide an interface to the revenue generator A 110A allowing the revenue generator A 110A to associate the advertising campaigns with the MNOs 115A-N. At block 430 the service provider 130 may receive, from the revenue generator A 110A via the interface, an indication of the MNOs 115A-N to be associated with each advertising campaign.

At block 435 the service provider 130 may determine whether the revenue generator A 110A has mobile advertisements to associate with the advertising campaigns or whether mobile advertisements need to be created to associate with the advertising campaigns. If, at block 435, mobile advertisements need to be created, the system 100 may move to block 450. At block 450 the service provider 130 may provide the revenue generator A 110A with an interface for creating mobile listings, mobile call offers, or generally any mobile advertisement. Alternatively or in addition, the service provider 130 may automatically create mobile advertisements for the revenue generator A 110A based on the existing web advertisements of the revenue generator A 110A and/or the account information of the revenue generator A 110A. For example, the service provider may take the title, or display text of an existing web advertisement and use it as the display text of a mobile advertisement. The service provider A 110A may use a phone number associated with the account of the revenue generator A 110A for a mobile call offer. Alternatively or in addition the service provider 130 may use the URL of the web site of the revenue generator A 110A as the destination URL in a mobile listing.

If, at block 435, mobile advertisements do not need to be created, the system 100 may move to block 440. At block 440 the service provider 130 may receive one or more mobile advertisements from the revenue generator A 110A. At block 460 the service provider 130 may associate the mobile advertisements with the ad campaigns and MNOs 115A-N identified by the revenue generator A 110A in block 430. Alternatively or in addition the revenue generator A 110A may identify individual ad campaigns to associate with each of the mobile advertisements.

At block 470 the service provider 130 may associate the ad groups within each advertising campaign with the mobile advertisements. At block 480 the service provider 130 may receive a search query from a user AA 120AA on a mobile device 220AA associated with the MNO A 115A. The search query may be a query associated with one of the ad groups of the revenue generator A 110A and the MNO A 115A. At block 490 the service provider 130 may provide one of the mobile advertisements of the revenue generator A 110A associated with the ad group and the MNO A 115A to the user AA 120AA.

Alternatively or in addition the ad campaigns of the revenue generator A 110A may include behavioral targeting advertising and/or content matching advertising tactics. In the case of behavioral targeting the service provider 130 may provide one of the mobile advertisements of the revenue generator A 110A to a user AA 120AA on a mobile device 220AA associated with the mobile carrier A 115A if the mobile behavior of the user AA 120AA coincides with the behavioral profile being targeted. The service provider 130 may attempt to link the behavioral profiles of the user AA 120AA on the web and on the MNOs 115A-N. In the case of content matching, the service provider 130 may display a mobile advertisement of the revenue generator A 110A when the content of a mobile page being viewed by the user AA 120AA matches the content targeted by the ad campaign.

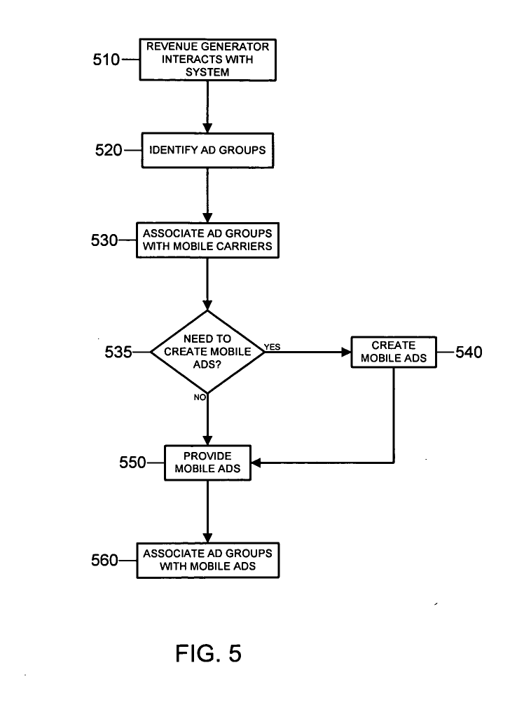

FIG. 5 is a flowchart illustrating operations of a revenue generator in the system of FIG. 1, or other systems for adapting online advertising campaigns to incorporate mobile advertising. At block 510 the revenue generator A 110A may interact with the service provider 130, such as by logging into the system 100. At block 520 the revenue generator A 110A may use an interface provided by the service provider 130 to identify one or more ad groups. At block 530 the revenue generator A 110A may use an interface provided by the revenue generator A 110A to associate the identified ad groups with the MNOs 115A-N. At block 535 the revenue generator A 110A may identify whether they need to create mobile advertisements.

If, at block 535, the revenue generator A 110A needs to create mobile advertisements, the system 100 may move to block 540. At block 540 the revenue generator A 110A may use an interface provided by the service provider 130 to create one or more mobile advertisements. Alternatively or in addition, the service provider 130 may automatically create mobile advertisements for the revenue generator A 110A based on the existing web advertisements of the revenue generator A 110A and/or the account information of the revenue generator A 110A.

If at block 535, the revenue generator A 110A does not need to create mobile advertisements, the system 100 may move to block 550. At block 550 the revenue generator A 110 may provide existing mobile advertisements to the service provider 130. At block 560 the revenue generator A 110A may use an interface provided by the service provider 130 to associate the ad groups with the mobile advertisements. The revenue generator A 110A may select one or more mobile advertisements to associate with each ad group. The service provider 130 may store the associations identified by the revenue generator A 110A in the data store 245.

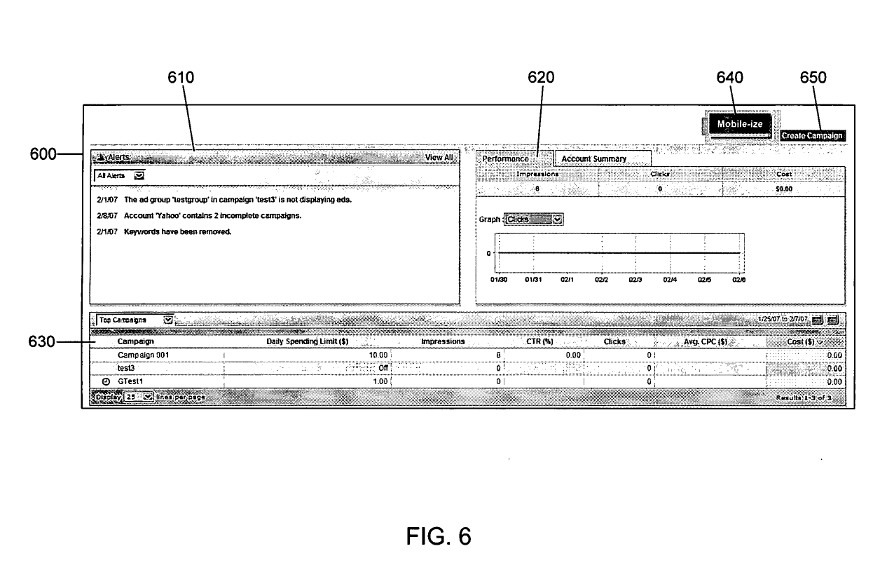

FIG. 6 is a screenshot 600 of a revenue generator's advertising campaign interface in the system of FIG. 1, or other systems for adapting online advertising campaigns to incorporate mobile advertising. The service provider 130 may provide the revenue generator A 110A with the screenshot 600 when the revenue generator A 110A logs into the system 100. The screenshot 600 may include a alert subsection 610, a performance subsection 620, a campaign subsection 630, a mobile-ize button 640 and a create campaign button 650.

In operation, the alert subsection 610 may display one or more alerts relating to the advertising account of the revenue generator A 110A. The alerts may include billing information, modifications to campaigns or ad groups, or generally any information that may be of use to the revenue generator A 110A. The performance subsection 620 may display the performance of the advertising campaigns of the revenue generator A 110A. The campaign subsection 630 may display the current campaigns of the revenue generator A 110A. The revenue generator A 110A may add a new campaign by clicking on the create campaign button 650. The revenue generator A 110A may begin the process of incorporating mobile advertising into one or more campaigns by clicking on the mobile-ize button 640.

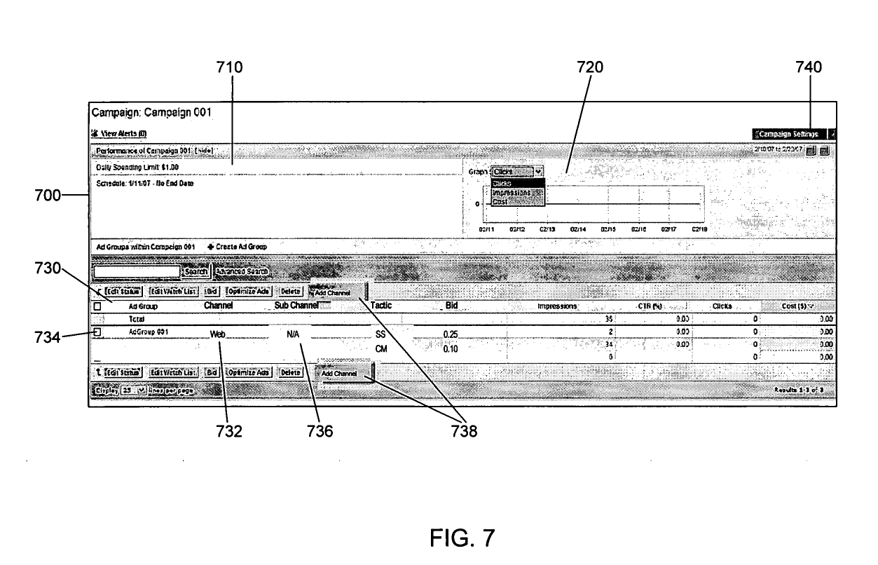

FIG. 7 is a screenshot 700 of a revenue generator's advertising group interface in the system of FIG. 1, or other systems for adapting online advertising campaigns to incorporate mobile advertising. The service provider 130 may provide the screenshot 700 to the revenue generator A 110A when the revenue generator A 110A clicks on the mobile-ize button 640 in the screenshot 600. The screenshot 700 may include an information subsection 710, a performance subsection 720, an ad group table 730, and a campaign settings button 740. The ad group table 730 may include a channel column 732, a checkbox column 734, a subchannel column 736, and ad channel buttons 738.

In operation the revenue generator A 110A may view information regarding the ad groups in the information subsection 710. The revenue generator A 110A may view performance information in the performance subsection 720. In the ad group table 730, the channel column 732 may display the advertising channels associated with each ad group, such as the web advertising channel and/or the mobile advertising channel. In the screenshot 700, the revenue generator A 110A has not incorporated mobile advertising into the ad groups, so the mobile channel does not appear in the channel column 732. The subchannel column 736 may refer to any segmentation of the advertising channels, such as the individual MNOs 115A-N in the mobile advertising channel.

The revenue generator A 110A may select one or more ad groups by clicking on the checkbox in the checkbox column 734. The revenue generator A 110A may add a channel, such as mobile advertising, to an ad group by clicking one of the add channel buttons 738.

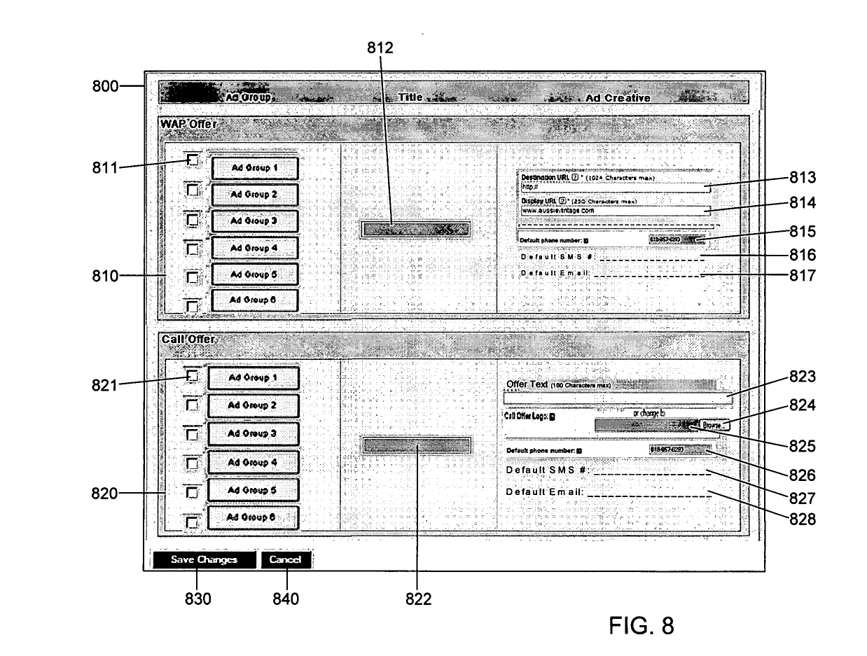

FIG. 8 is a screenshot 800 of a revenue generator's advertising group mobilization interface in the system of FIG. 1, or other systems for adapting online advertising campaigns to incorporate mobile advertising. The service provider 130 may provide the screenshot 800 to the revenue generator A 110A when the revenue generator A 110A selects an ad group and clicks on the add channel button 738 in the screenshot 700. The screenshot 800 may include a mobile listing subsection 810, a mobile call offer subsection 820, a save changes button 830, and a cancel button 840. The mobile listing subsection 810 may include mobile listing checkboxes 811, a mobile listing title field 812, a mobile listing destination URL field 813, a mobile listing display URL field 814, a mobile listing phone number field 815, a mobile listing SMS field 816, and a mobile listing email field 817. The mobile call offer subsection 820 may include call offer checkboxes 821, a call offer title field 822, a call offer text field 823, a call offer logo field 825, a browse button 824, a call offer phone number field 826, a call offer SMS field 827, and a call offer email field 828.

In operation the revenue generator A 110A may create a mobile listing or a mobile call offer in the screenshot 800 and may link the mobile listing or mobile call offer with one or more ad groups. The revenue generator A 110A may select the one or more ad groups to associate with a mobile listing by clicking on the mobile listing checkbox 811 next to the ad group. The revenue generator A 110A may create the mobile listing, or WAP offer, in the mobile listing subsection 810. The title of the mobile listing may be entered in the mobile listing title field 812. The destination URL associated with the mobile listing may be entered in the mobile listing destination URL field 813. The display URL associated with the mobile listing may be entered in the mobile listing display URL field 814. The phone number associated with the mobile listing may be entered in the mobile listing phone number field 815. The SMS number associated with the mobile listing may be entered in the mobile listing SMS field 816. The email address associated with the mobile listing may be entered in the mobile listing email field 817. The service provider 130 may display the information entered in one or more of these fields in a mobile advertisement provided to a user AA 120AA. The destination URL may be the URL the user AA 120AA may be taken to if the user AA 120AA clicks on the mobile advertisement.

The revenue generator A 110A may select the one or more ad groups to associate with a mobile call offer by clicking on the mobile call offer checkbox 821 next to the ad group. The revenue generator A 110A may create a mobile call offer, or call offer, in the mobile call offer subsection 820. The title of the mobile call offer may be entered in the mobile call offer title field 822. The offer text associated with the mobile call offer may be entered into the mobile call offer text field 823. The logo associated with the call offer may be entered in the mobile call offer logo field 825. The revenue generator A 110A may select a mobile call offer logo by clicking on the browse button 824. The phone number associated with the mobile call offer may be entered in the mobile call offer phone number field 826. The SMS associated with the mobile call offer may be entered in the mobile call offer SMS field 827. The email associated with the mobile call offer may be entered in the mobile call offer email field 828. The service provider 130 may display information entered in one or more of these fields in a mobile advertisement provided to a user AA 120AA. The offer text and the offer logo may be displayed to the user AA 120AA and the mobile call offer phone number may be provided to the user AA 120AA if the user AA 120AA clicks on the mobile advertisement.

The revenue generator A 110A can save the changes made by clicking on the save changes button 830. The revenue generator A 110A may cancel any changes made by clicking on the cancel button 840.

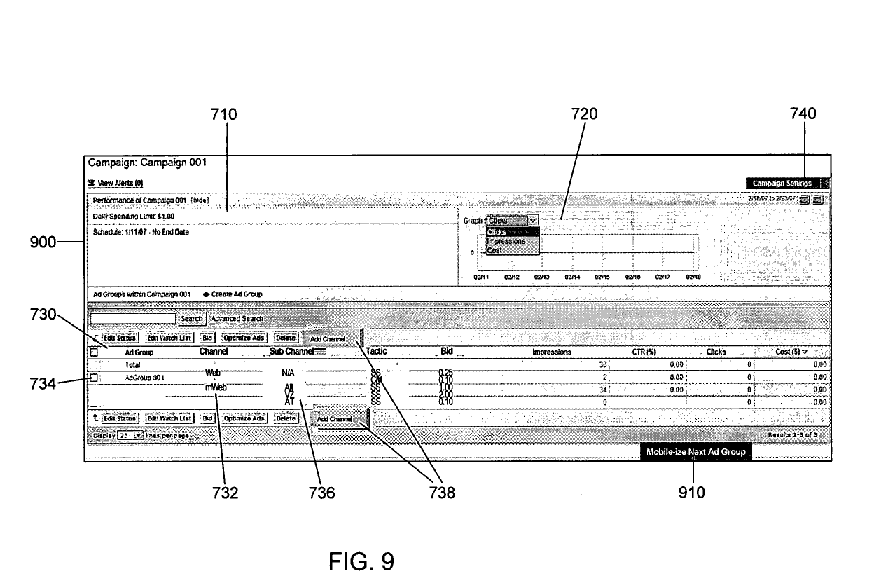

FIG. 9 is a screenshot of a revenue generator's advertising group interface displaying mobilized advertising groups in the system of FIG. 1, or other systems for adapting online advertising campaigns to incorporate mobile advertising. The service provider 130 may provide the screenshot 900 to the revenue generator A 110A after the revenue generator A 110A incorporates mobile advertising into one or more ad groups. The screenshot 900 may include an information subsection 710, a performance subsection 720, an ad group table 730, a campaign settings button 740, and a mobile-ize next ad group button 910. The ad group table 730 may include a channel column 732, a checkbox column 734, a subchannel column 736, and ad channel buttons 738.

In operation, the ad group table 730 may display the channels and subchannels associated with each ad group. In the screenshot 900 the channel column 732 shows that the revenue generator A 110A created a mobile channel for the ad group. The subchannel column 736 shows that the revenue generator A 110A associated the ad group with several of the MNOs 115A-N, designated by “All,” “VZ,” and, “AT.” The revenue generator A 110A may incorporate mobile advertising into an additional ad group by checking a checkbox 734 next to an ad group and clicking on the mobile-ize next ad group button 910. The service provider 130 may provide the revenue generator A 110A with the screenshot 700 when the revenue generator A 110A clicks on the mobile-ize next ad group button 910.

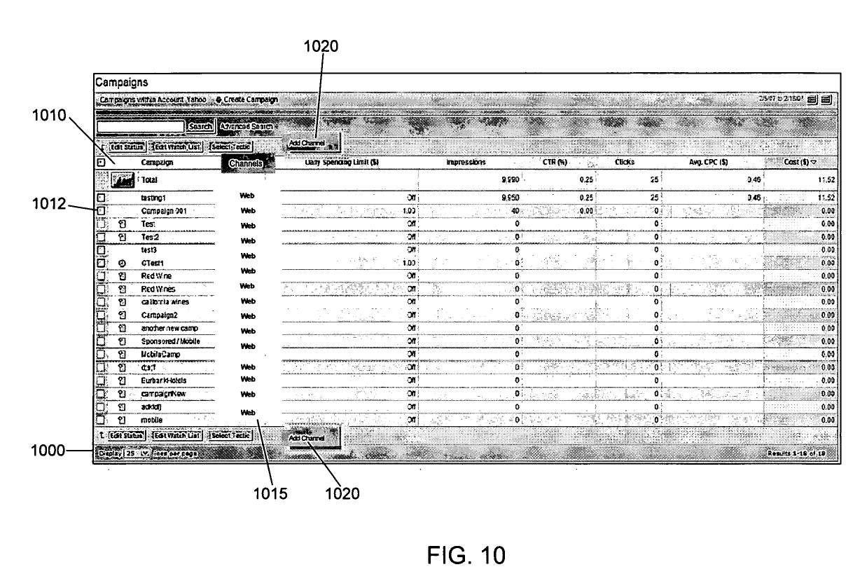

FIG. 10 is a screenshot of a revenue generator's advertising campaign interface in the system of FIG. 1, or other systems for adapting online advertising campaigns to incorporate mobile advertising. The service provider 130 may provide the screenshot 1000 to the revenue generator A 110A in a system 100 where mobile advertising is incorporated at the campaign level. The screenshot 1000 may include a campaign table 1010 and an add channel button 1020. The campaign table 1010 may include checkboxes 1012, and a channel column 1015.

In operation the revenue generator A 110A may view information about each of the campaigns in the campaign table 1010. The revenue generator A 110A may select one or more campaigns to incorporate mobile advertising into by clicking the checkbox 1012 next to the campaign and clicking on the add channel button 1020.

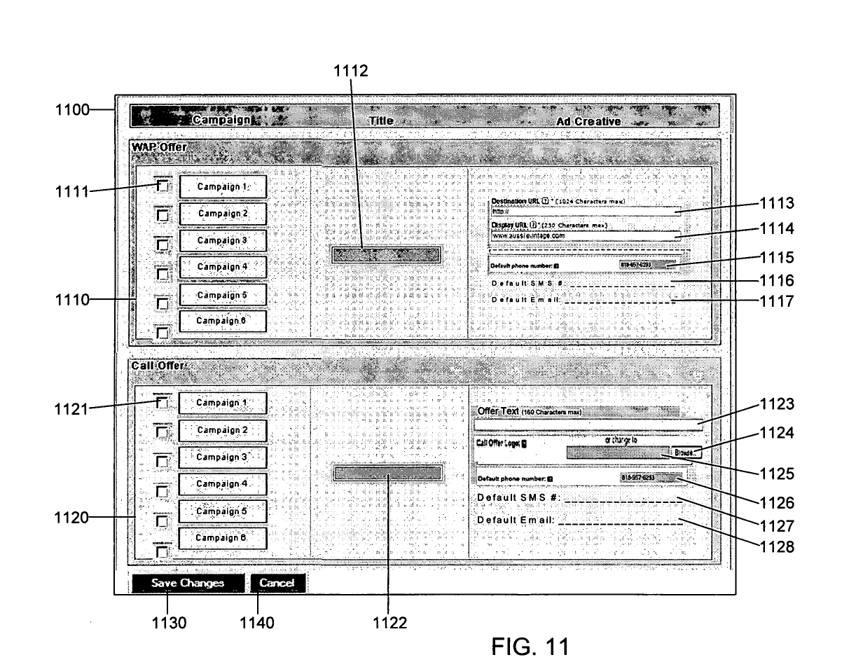

FIG. 11 is a screenshot of a revenue generator's advertising campaign mobilization interface in the system of FIG. 1, or other systems for adapting online advertising campaigns to incorporate mobile advertising. The service provider 130 may provide the screenshot 1100 to the revenue generator A 10A when the revenue generator A 110A checks a checkbox 1012 and clicks on the add channel button 1020 in the screenshot 1000. The screenshot 1100 may include a mobile listing subsection 1110, a mobile call offer subsection 1120, a save changes button 1130, and a cancel button 1140. The mobile listing subsection 1110 may include mobile listing checkboxes 1111, a mobile listing title field 1112, a mobile listing destination URL field 1113, a mobile listing display URL field 1114, a mobile listing phone number field 1115, a mobile listing SMS field 1116, and a mobile listing email field 1117. The mobile call offer subsection 1120 may include call offer checkboxes 1121, a call offer title field 1122, a call offer text field 1123, a call offer logo field 1125, a browse button 1124, a call offer phone number field 1126, a call offer SMS field 1127, and a call offer email field 1128.

In operation the revenue generator A 110A may create a mobile listing or a mobile call offer in the screenshot 1100 and may link the mobile listing or mobile call offer with one or more ad campaigns. The revenue generator A 110A may select the one or more ad campaigns to associate with a mobile listing by clicking on the mobile listing checkbox 1111 next to the ad campaign. The revenue generator A 110A may create the mobile listing, or WAP offer, in the mobile listing subsection 1110. The title of the mobile listing may be entered in the mobile listing title field 1112. The destination URL associated with the mobile listing may be entered in the mobile listing destination URL field 1113. The display URL associated with the mobile listing may be entered in the mobile listing display URL field 1114. The phone number associated with the mobile listing may be entered in the mobile listing phone number field 1115. The SMS number associated with the mobile listing may be entered in the mobile listing SMS field 1116. The email address associated with the mobile listing may be entered in the mobile listing email field 1117. The service provider 130 may display the information entered in these fields in a mobile advertisement provided to a user AA 120AA. The destination URL may be the URL the user AA 120AA may be taken to if the user AA 120AA clicks on the mobile advertisement.

The revenue generator A 110A may select the one or more ad groups to associate with a mobile call offer by clicking on the mobile call offer checkbox 1121 next to the ad group. The revenue generator A 110A may create a mobile call offer, or call offer, in the mobile call offer subsection 1120. The title of the mobile call offer may be entered in the mobile call offer title field 1122. The offer text associated with the mobile call offer may be entered into the mobile call offer text field 1123. The logo associated with the call offer may be entered in the mobile call offer logo field 1125. The revenue generator A 110A may select a mobile call offer logo by clicking on the browse button 1124. The phone number associated with the mobile call offer may be entered in the mobile call offer phone number field 1126. The SMS associated with the mobile call offer may be entered in the mobile call offer SMS field 1127. The email associated with the mobile call offer may be entered in the mobile call offer email field 1128. The service provider 130 may display information entered in the fields in a mobile advertisement provided to a user AA 120AA. The offer text and the offer logo may be displayed to the user AA 120AA and the mobile call offer phone number may be provided to the user AA 120AA if the user AA 120AA clicks on the mobile advertisement.

The revenue generator A 110A can save the changes made by clicking on the save changes button 1130. The revenue generator A 110A may cancel any changes made by clicking on the cancel button 1140.

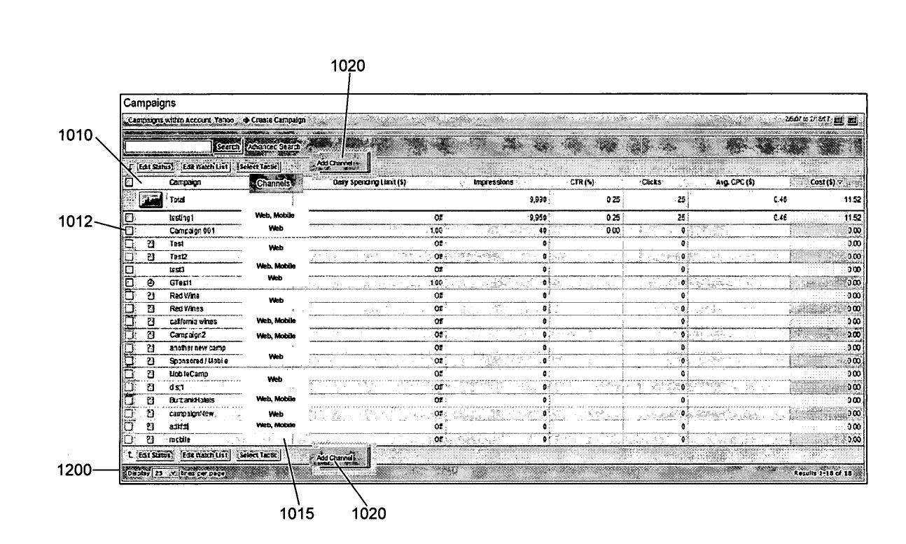

FIG. 12 is a screenshot of a revenue generator's advertising campaign interface displaying mobilized advertising campaigns in the system of FIG. 1, or other systems for adapting online advertising campaigns to incorporate mobile advertising. The service provider 130 may display the screenshot 1200 to the revenue generator A 110A after the revenue generator A 110A has incorporated mobile advertising into one or more advertising campaigns. The screenshot 1200 may include a campaign table 1010 and an add channel button 1020. The campaign table 1010 may include checkboxes 1012, and a channel column 1015.

In operation the revenue generator A 110A may view information about each of the campaigns in the campaign table 1010. The channel field 1015 may display the ad campaigns associated with web advertising and/or mobile advertising. The revenue generator A 110A may select one or more additional campaigns to incorporate with mobile advertising by clicking the checkbox 1012 next to the campaign and clicking on the add channel button 1020.

FIG. 13 illustrates a general computer system 1300, which may represent a service provider server 240, a third party server 250, an advertising services server 260, one of the mobile devices 220AA-NN or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1300 may include a set of instructions 1324 that may be executed to cause the computer system 1300 to perform any one or more of the methods or computer based functions disclosed herein. The computer system 1300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1324 (sequential or otherwise) that specify actions to be taken by that machine. In a particular embodiment, the computer system 1300 may be implemented using electronic devices that provide voice, video or data communication. Further, while a single computer system 1300 may be illustrated, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, such as, a central processing unit (CPU), a graphics processing unit (GPU), or both. The processor 1302 may be a component in a variety of systems. For example, the processor 1302 may be part of a standard personal computer or a workstation. The processor 1302 may be one or more general processors, digital signal processors, application specific integrated circuits, field programmable gate arrays, servers, networks, digital circuits, analog circuits, combinations thereof, or other now known or later developed devices for analyzing and processing data. The processor 1302 may implement a software program, such as code generated manually (i.e., programmed).

The computer system 1300 may include a memory 1304 that can communicate via a bus 1308. The memory 1304 may be a main memory, a static memory, or a dynamic memory. The memory 1304 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1304 may include a cache or random access memory for the processor 1302. Alternatively or in addition, the memory 1304 may be separate from the processor 1302, such as a cache memory of a processor, the system memory, or other memory. The memory 1304 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1304 may be operable to store instructions 1324 executable by the processor 1302. The functions, acts or tasks illustrated in the figures or described herein may be performed by the programmed processor 1302 executing the instructions 1324 stored in the memory 1304. The functions, acts or tasks may be independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

The computer system 1300 may further include a display 1314, such as a liquid crystal display (LCD), an organic light emitting diode (OLED), a flat panel display, a solid state display, a cathode ray tube (CRT), a projector, a printer or other now known or later developed display device for outputting determined information. The display 1314 may act as an interface for the user to see the functioning of the processor 1302, or specifically as an interface with the software stored in the memory 1304 or in the drive unit 1306.

Additionally, the computer system 1300 may include an input device 1312 configured to allow a user to interact with any of the components of system 1300. The input device 1312 may be a number pad, a keyboard, or a cursor control device, such as a mouse, or a joystick, touch screen display, remote control or any other device operative to interact with the system 1300.

The computer system 1300 may also include a disk or optical drive unit 1306. The disk drive unit 1306 may include a computer-readable medium 1322 in which one or more sets of instructions 1324, e.g. software, can be embedded. Further, the instructions 1324 may perform one or more of the methods or logic as described herein. The instructions 1324 may reside completely, or at least partially, within the memory 1304 and/or within the processor 1302 during execution by the computer system 1300. The memory 1304 and the processor 1302 also may include computer-readable media as discussed above.

The present disclosure contemplates a computer-readable medium 1322 that includes instructions 1324 or receives and executes instructions 1324 responsive to a propagated signal; so that a device connected to a network 235 may communicate voice, video, audio, images or any other data over the network 235. The instructions 1324 may be implemented with hardware, software and/or firmware, or any combination thereof. Further, the instructions 1324 may be transmitted or received over the network 235 via a communication interface 1318. The communication interface 1318 may be a part of the processor 1302 or may be a separate component. The communication interface 1318 may be created in software or may be a physical connection in hardware. The communication interface 1318 may be configured to connect with a network 235, external media, the display 1314, or any other components in system 1300, or combinations thereof. The connection with the network 235 may be a physical connection, such as a wired Ethernet connection or may be established wirelessly as discussed below. Likewise, the additional connections with other components of the system 1300 may be physical connections or may be established wirelessly. In the case of a service provider server 240, a third party server 250, an advertising services server 260, the servers may communicate with users 120AA-NN and the revenue generators 110A-N through the communication interface 1318.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1322 may be a single medium, or the computer-readable medium 1322 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1322 may include a solid-state memory such as a memory card or other package that houses one or more non-volatile read-only memories. The computer-readable medium 1322 also may be a random access memory or other volatile re-writable memory. Additionally, the computer-readable medium 1322 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of adapting online advertising campaigns to incorporate mobile advertising, the method comprising:
identifying one or more ad groups of an advertiser, each ad group comprising of one or more keywords and one or more web advertisements;
providing an interface allowing the advertiser to associate the one or more ad groups with one or more mobile carriers;
receiving, from the advertiser, one or more associations of the one or more ad groups and the one or more mobile carriers;
creating one or more mobile advertisements based on the one or more web advertisements and the one or more mobile carriers;
associating the one or more mobile advertisements and the one or more mobile carriers with the one or more ad groups; and
providing at least one of the one or more mobile advertisements to a user when the user performs a mobile search for at least one of the one or more keywords on a mobile device associated with at least one of the one or more mobile carriers.

2. The method of claim 1 wherein the one or more mobile advertisements comprises at least one of a mobile listing and a mobile call offer.

3. The method of claim 1 further comprising formatting the one or more mobile advertisements for display on a device associated with at least one of the one or more mobile carriers.

4. The method of claim 1 wherein providing the one or more mobile advertisements to the user further comprises causing the one or more mobile advertisements to be displayed on a mobile device of the user.

5. The method of claim 1 wherein generating one or more mobile advertisements based on the one or more web advertisements further comprises generating one or more mobile advertisements based on a title of each of the one or more web advertisements.

6. The method of claim 1 wherein the interface is accessible via a web browser.

7. A method of mobilizing an existing online advertising campaign, the method comprising:
identifying one or more ad groups of an advertiser, each ad group comprising of one or more keywords and one or more web advertisements;
providing an interface allowing the advertiser to create one or more mobile advertisements and associate the one or more ad groups with the one or more mobile advertisements and one or more mobile carriers;
receiving, from the advertiser, the one or more mobile advertisements, and one or more associations of the one or more mobile advertisements, the one or more ad groups, and the one or more mobile carriers;
providing the one or more mobile advertisements to a user when the user performs a mobile search for the one or more keywords through the one or more mobile carriers; and
providing the one or more web advertisements to the user when the user searches for the one or more keywords on the web.

8. The method of claim 7 wherein the one or more mobile advertisements comprises at least one of a mobile listing and a mobile call offer.

9. The method of claim 7 further comprising formatting the one or more mobile advertisements for display on a mobile device associated with at least one of the one or more mobile carriers.

10. The method of claim 7 wherein providing the one or more mobile advertisements to the user further comprises causing the one or more mobile advertisements to be displayed on a mobile device of the user.

11. The method of claim 7 wherein providing the one or more web advertisements to the user further comprises causing the one or more web advertisements to be displayed on a web device of the user.

12. The method of claim 7 wherein the interface is accessible via a web browser.

13. A method of mobilizing an existing online advertising campaign, the method comprising:
identifying one or more online advertising campaigns of an advertiser, each campaign comprising one or more ad groups, each ad group comprising of one or more keywords and one or more web advertisements;
providing an interface allowing the advertiser to associate the one or more online advertising campaigns with one or more mobile advertisements and one or more mobile carriers;
receiving, from the advertiser, one or more associations of one or more advertising campaigns, one or more mobile carriers, and one or more mobile advertisements;
associating the one or more online advertising campaigns with one or more mobile advertisements and the one or more mobile carriers;
providing the one or more mobile advertisements to a user when the user performs a mobile search for the one or more keywords through the one or more mobile carriers; and
providing the one or more web advertisements to the user when the user searches for the one or more keywords on the web.

14. The method of claim 13 wherein the one or more mobile advertisements comprises at least one of a mobile listing and a mobile call offer.

15. The method of claim 13 further comprising formatting the one or more mobile advertisements for display on a device associated with at least one of the one or more mobile carriers.

16. The method of claim 13 wherein providing the one or more mobile advertisements to the user further comprises causing the one or more mobile advertisements to be displayed on a mobile device of the user.

17. The method of claim 13 wherein providing the one or more web advertisements to the user further comprises causing the one or more web advertisements to be displayed on a web device of the user.

18. The method of claim 13 wherein the interface is accessible via a web browser.

19. A system for adapting online advertising campaigns to incorporate mobile advertising, comprising:
a memory to store one or more ad groups of an advertiser, each ad group comprising one or more keywords and one or more web advertisements, and one or more mobile advertisements;
an interface operatively connected to the memory to communicate with the advertiser and a user, and allow the advertiser to associate the one or more ad groups with one or more mobile carriers; and
a processor operatively connected to the memory and the interface the processor for running instructions, wherein the processor identifies the one or more ad groups, provides the interface to the advertiser, receives, from the advertiser, one or more associations of the one or more ad groups and the one or more mobile carriers, creates one or more mobile advertisements based on the one or more web advertisements and the one or more mobile carriers, associates the one or more mobile advertisements and the one or more mobile carriers with the one or more ad groups, and provides at least one of the one or more mobile advertisements to the user when the user performs a mobile search for at least one of the one or more keywords on a mobile device associated with at least one of the one or more mobile carriers.

20. The system of claim 19 wherein the one or more mobile advertisements comprises at least one of a mobile listing and a mobile call offer.

21. The system claim 19 wherein the processor formats the one or more mobile advertisements for display on a device associated with at least one of the one or more mobile carriers.

22. The system of claim 19 wherein the processor causes the one or more mobile advertisements to be displayed on a mobile device of the user.

23. The method of claim 19 wherein the processor creates the one or more mobile advertisements based on a title of each of the one or more web advertisements.

24. The method of claim 19 wherein the interface is accessible via a web browser.
